(19) United States
(12) Patent Application Publication
(10) Pub. No.: US 2019/0277576 A1
(43) Pub. Date: Sep. 12, 2019

(54) HEAT EXCHANGER

(71) Applicant: SAFRAN, Paris (FR)

(72) Inventor: Ephraim TOUBIANA, Moissy Cramayel (FR)

(21) Appl. No.: 16/348,111

(22) PCT Filed: Nov. 9, 2017
(86) PCT No.: PCT/FR2017/053059

§ 371 Date: May 7, 2019

(30) Foreign Application Priority Data
Nov. 10, 2016 (FR) 1660886

(51) Int. Cl. F28D 21/00; B23K 26/342; B33Y 80/00; F28D 9/00; F28F 3/04; F28F 21/08

(52) U.S. Cl. CPC F28D 21/001; B23K 26/342; B33Y 80/00; B23K 2101/001; F28F 3/048; F28F 21/08; F28D 21/0003; F28D 9/0062

(57) ABSTRACT

Exchanger (1) of heat between a first fluid flowing in a longitudinal direction (X) and a second fluid, the said exchanger (1) comprising:
two parallel plates (6) distant from one another;
at least a first and second row (8a, 8b) of fins (9) arranged perpendicularly between the said plates (6), each fin (9) being delimited longitudinally by a first edge (10) and a second edge (11), the said first edge (10) comprising at each of its ends a region of connection with the corresponding plate (6);

characterised in that the said connection regions of the said first edge (10) are respectively inclined with respect to a normal to the plates (6) in a plane (P) perpendicular to the said plates (6) and parallel with the direction (X), the said first edge (10) and the said second edge (11) of each of the fins (9) having identical profiles in the said plane (P).

### TECHNICAL FIELD

The present invention relates to heat exchangers, in particular for a turbine engine.

### STATE OF THE ART

A turbine engine comprises a gas generator comprising, for example, from upstream to downstream in the gas flow direction, one or more compressor stages, a combustion chamber, one or more turbine stages, and a nozzle for ejecting exhaust gases.

A heat exchanger is installed in a turbine engine to make it possible for thermal energy transfer from one fluid to another.

Such a heat exchanger is, for example, used to transfer thermal energy from hot exhaust gases to a gas intended to be introduced upstream of the combustion chamber, favouring, in particular, the fuel consumption of the turbine engine. This heat exchanger can also be used to cool the lubricant (for example, oil) of the different means for guiding the rotors of the gas generator.

Such an exchanger is, for example, obtained by additive manufacturing by selectively melting on powder beds commonly designated by SLM (Selective Laser Melting). The SLM additive manufacturing principle is based on the melting of thin two-dimensional (2D) layers of powder (metal, plastic, ceramic, etc.) using a high-power laser. SLM technology has the advantage of making it possible to produce parts having complex geometric shapes and good mechanical characteristics.

With an equal aerothermal performance, heat exchangers with fins are particularly used in turbine engines, in particular because of their low mass.

Such a heat exchanger, between a first fluid (for example, hot exhaust gases) flowing in a longitudinal direction X and a second fluid (for example, air), comprises for example, two parallel plates distant from one another, so as to define a circulation passage for the first fluid and a plurality of rows of fins arranged perpendicularly between the plates.

More specifically, the rows of fins extend longitudinally. Each fin is delimited longitudinally by a leading edge and a trailing edge perpendicular to the plates.

Such an architecture has, in particular, the disadvantage of leading to a significant loss of mechanical energy from the first fluid, partially due to the presence of a recirculation region in the flow at the level of each of the leading edges of the fins. This recirculation area is all the more significant, because of the variation of the cross-sections for the passage of the first fluid, which cause local accelerations.

Furthermore, by SLM manufacturing, in a vertical orientation (plates and fins perpendicular to the construction support), such an architecture does not make it possible to respect the dimensional and geometric tolerances required from manufacturing. Indeed, the melting of an overhanging layer, of which the normal is parallel with the direction of adding layers, poses production difficulties, in particular due to the fact that only the non-melted powder serves as a support during the melting of such an overhanging layer.

The prior art also comprises documents WO-A2-2010/098666 and CN-A-104776736.

The aim of the present invention is thus to propose, a heat exchanger, with an equal mass, having improved aerothermal characteristics, and respecting the desired dimensional and geometric tolerances, when it is obtained by additive manufacturing by selective melting on powder beds.

### DESCRIPTION OF THE INVENTION

To this end, the invention proposes a heat exchanger between a first fluid flowing in a longitudinal direction X and a second fluid, said exchanger comprising:
two parallel plates distant from one another so as to define a circulation passage of said first fluid;
at least one first and one second row of fins arranged perpendicularly between said plates, said first and second rows extending longitudinally, the fins of said first row being arranged, preferably in staggered rows with respect to the fins of said second row, each fin being delimited longitudinally by a first edge and a second edge, said first edge comprising at each of the ends thereof, a region of connection with the corresponding plate;

characterised in that said regions of connection of said first edge are respectively inclined by an angle A and an angle B with respect to a normal N to the plates in a plane P perpendicular to said plates and parallel with the direction X, said first edge and said second edge of each of the fins having an identical profile in said plane P.

Such geometric characteristics associated with the fins make it possible, with an equal mass, not only to significantly improve the aerothermal performances of the exchanger, but also to respect the desired dimensional and geometric tolerances, when it is obtained by additive manufacturing by selective melting on powder beds.

Indeed, on the one hand, such geometric characteristics make it possible to significantly reduce the recirculation region in the flow at the level of each of the leading edges (first edge or second edge according to the direction of the flow) of the fins, and consequently, to reduce the mechanical energy losses. This reduction is all the more significant, due to there being no variations in the cross-sections for the passage of the first fluid. In comparison, with respect to the heat exchangers of the prior art, it is estimated that the reduction of the charge losses is around 15%.

On the other hand, for SLM manufacturing, by positioning the hollow edge on the side of the construction support if necessary, the regions of connection respectively constitute a first and a second primer for manufacturing the fin. Thus, during manufacturing, there is no overhang layer to melt and, in other words, the non-melted powder is not used as a support, favouring compliance with the required dimensional and geometric tolerances.

The exchanger according to the invention can comprise one or more of the following characteristics, taken individually from one another, or combined with one another:
the angle A is equal to the angle B;
the angle A and/or the angle B is greater than 40°, and preferably greater than or equal to 45°;
in the plane P, more than 90% of the length of the first edge is inclined with respect to the normal N, and preferably more than 95%;
said first edge comprises at least one rectilinear section inclined with respect to the normal N and/or at least one circular section and/or at least one elliptic section;
said first edge comprises two rectilinear sections inclined with respect to the normal N and having concurrent directions;
the fins are spaced longitudinally by a constant amount.

The invention has as a second object, a method for producing an exchanger such as described above, wherein it comprises a step of producing said exchanger by additive manufacturing by selective melting on powder beds along a manufacturing axis Z parallel with said longitudinal direction X.

Alternatively, said fins each comprise a first hollow edge and a second protruding edge, the exchanger being manufactured on a construction support, said first hollow edge being oriented on the side of said support.

The invention has as a third object, a turbine engine comprising a heat exchanger such as described above.

### DESCRIPTION OF THE FIGURES

The invention will be best understood, and other details, characteristics and advantages of the invention will appear more clearly upon reading the following description made by way of a non-limiting example and with reference to the appended drawings, in which:

FIGS. 1 and 2 are perspective views of a heat exchanger (with two stages) according to the invention, each stage comprising two plates and a plurality of rows of fins arranged between the plates, according to a first embodiment;

FIG. 3 is a detailed view of a fin of the heat exchanger of FIGS. 1 and 2, in a plane P;

FIG. 4 is a perspective view of a heat exchanger, according to a second embodiment;

FIG. 5 is a detailed view of a fin of the heat exchanger of FIG. 4, in a plane P;

FIG. 6 is a schematic view of a machine for producing an exchanger (or an exchanger stage) according to the invention, by additive manufacturing;

FIGS. 7 to 10 are detailed views, in a plane P, similar to those of FIGS. 3 to 5, and illustrate embodiment variants of the fins according to the invention.

### DETAILED DESCRIPTION

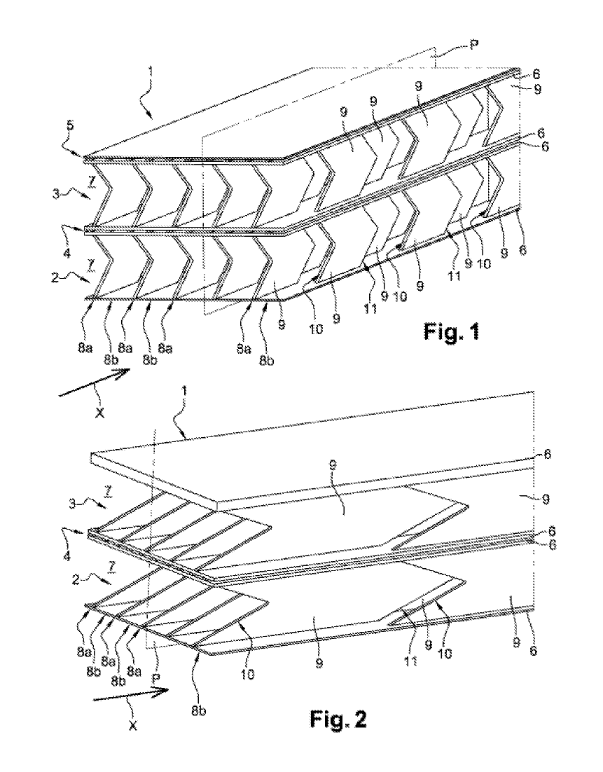

In FIGS. 1 and 2, a heat exchanger 1 between a first fluid (for example, hot exhaust gases) flowing in a longitudinal direction X and a second fluid (for example, air) is represented.

More specifically, the exchanger 1 is staged, namely a first and a second stage 2, 3 for circulating the first fluid. A first path 4 for circulating the second fluid is arranged between the first and second stages 2, 3 (inter-stage circulation path). A second path 5 for circulating the second fluid (not represented in FIG. 2) is arranged on the free side of the second stage 3.

The example illustrated is in no way limiting, according to needs, the exchanger 1 could have a number N of stages, each defining a passage for circulating the first fluid, two adjacent stages being separated by a path for circulating the second fluid.

It must be noted, that the flow of the first fluid in the longitudinal direction X can be from upstream to downstream (such as illustrated in FIG. 1) or from downstream to upstream.

In the heat exchanger 1, there is no mixture between the first and the second fluid.

Each stage 2, 3 of the exchanger 1 comprises two parallel plates 6 distant from one another, so as to define a passage 7 for circulating the first fluid and a plurality of rows 8a, 8b (in this case, ten) of heat-conductive fins 9 arranged perpendicularly between said plates 6.

More specifically, the rows 8a, 8b extend longitudinally (in the direction X). The fins 9 of two adjacent rows 8a, 8b are arranged in staggered rows. Each fin 9 is delimited longitudinally by a first edge 10 and a second edge 11, the first edge 10 comprises, at each of the ends thereof, a region of connection 12a, 12b with the corresponding plate 6.

The regions of connection 12a, 12b of the first edge 10 are respectively inclined by an angle A and by an angle B with respect to a normal N to the plates 6, in a plane P perpendicular to the plates 6 and parallel with the direction X. The first edge 10 and the second edge 11 of each of the fins 9 have an identical profile, in the plane P.

According to the embodiment illustrated in FIGS. 1 to 2 (respectively on the embodiment of FIG. 4), the fins 9 are identical (i.e. they have the same geometric and dimensional characteristics) and spaced longitudinally by a constant amount (or clearance). On one same row 8a, 8b, two consecutive fins 9 are spaced by an interval equal to one fin 9 (and more specifically, to the longitudinal dimension of one fin 9).

The term “staggered-row arrangement”, means a repetitive arrangement, row by row, where in one row out of two, the fins 9 are offset by half a step with respect to the adjacent rows.

In a variant, the spacing could be variable or the exchanger 1 could be divided longitudinally into portions, each portion having its own spacing.

In a variant, the fins 9 of two adjacent rows 8a, 8b could be partially covered, in the plane P.

According to the invention, in a plane P, when the region of connection 12a is rectilinear, the angle A (respectively for the angle B) corresponds to the angle between the region of connection 12a and the normal N.

According to the invention, in a plane P, when the region of connection 12a (respectively region of connection 12b) is curved, the angle A (respectively for the angle B) corresponds to the angle between the tangent T to the region of connection 12a (at the level of a point located in the proximity of the corresponding plate 6) and the normal N.

Advantageously, in a plane P, more than 90% of the length of the first edge 10 (respectively of the second edge 11) is inclined with respect to the normal N, and preferably more than 95%.

The angle A and/or the angle B is greater than 40°, and preferably greater than or equal to 45°.

According to a first embodiment illustrated in FIGS. 1 to 3, for each fin 9, in a plane P, the first edge 10 (respectively the second edge 11) comprises two rectilinear sections 13 inclined with respect to the normal N and having concurrent directions.

More specifically, the first edge 10 has a general V shape. Each of the rectilinear sections 13 converges from the corresponding plate 6. The two rectilinear sections 13 are sealed by a fillet 14 (concave shape). The angle A is equal to the angle B, and is equal to 45°.

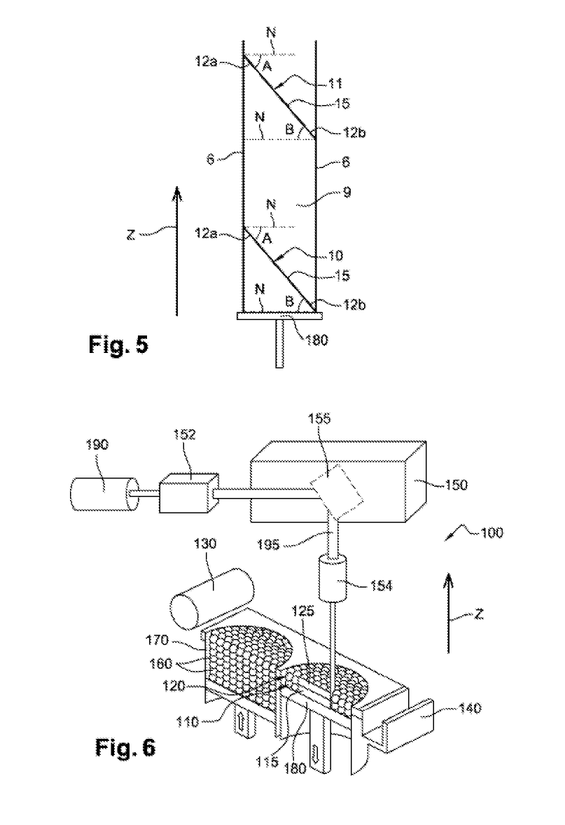

According to a second embodiment illustrated in FIGS. 4 and 5, for each fin 9, in a plane P, the first edge 10 comprises one single rectilinear section 15 inclined with respect to the normal N. Each fin 9 thus has a parallelogram shape. The angle A is equal to the angle B, and is equal to 45°.

FIG. 6 shows a machine 100 for manufacturing a heat exchanger 1 or a stage 2, 3 of the exchanger 1 by additive manufacturing, and in particular by selective melting of powder layers 160 with a high-energy beam 195.

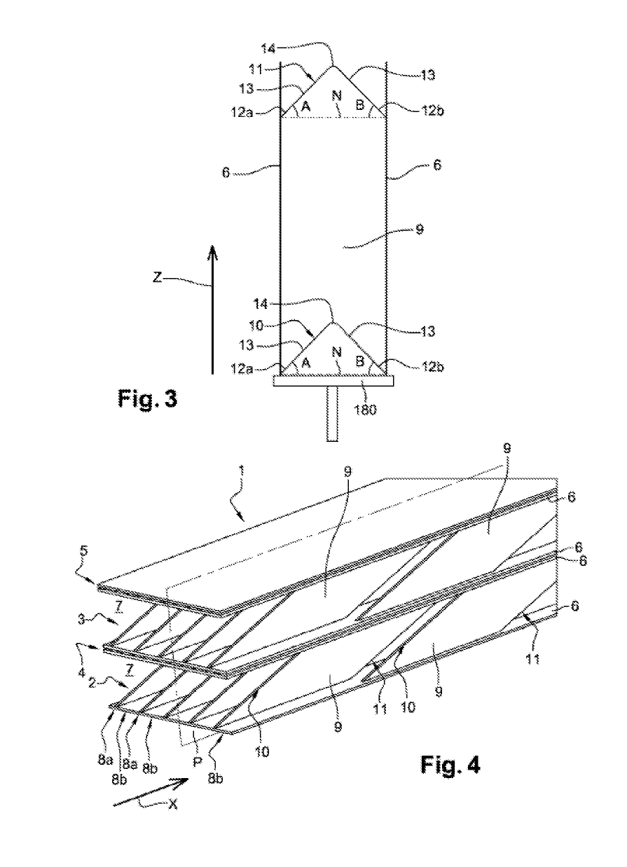

The heat exchanger 1 (or the stage 2, 3 of the exchanger 1) is advantageously manufactured along a manufacturing axis Z parallel with the longitudinal direction X (plates 6 and fins 9 perpendicular to the construction support 180) (see FIGS. 3 and 5).

The machine 100 comprises a feed tray 170 containing the powder 160 (metal in the present case), a roller 130 to decant this powder 160 from the tray 170 and to spread a first layer 110 of this powder 160 on a construction support 180 mobile in translation along the manufacturing axis Z (the support 180 can be, for example, a plate, a portion of another part or a gate).

The machine 100 also comprises a recycling tray 140 to recover the excess powder 160 after spreading the layer of powder with the roller 130 on the construction support 180.

The machine 100 further comprises a laser beam 195 generator 190, and a steering system 150 capable of directing this beam 195 over all of the construction support 180, so as to melt the desired powder portions 160. The shaping of the laser beam 195 and the variation in the diameter thereof over the focal plane are done respectively by means of a beam dilator 152 and a focussing system 154, all constituting the optical system.

More specifically, the steering system 150 comprises, for example, at least one mirror 155 that can be oriented, on which the laser beam 195 is reflected before reaching the powder layer 160. The angular position of this mirror 155 is controlled, for example, by a galvanometric head such that the laser beam 195 scans the desired portions of the first layer 110 of powder 160, according to a pre-established profile.

The heat exchanger 1 (or the stage 2, 3 of the exchanger 1) is manufactured along the manufacturing axis Z (parallel with the direction X) (plates 6 and fins 9 perpendicular to the construction support 180). Such as illustrated in FIG. 3, when the profile of the fins 9 comprises a hollow edge 10 and a protruding edge 11, the hollow edges 10 must be oriented on the side of the construction plate in order to avoid any overhanging layer from being melted.

The manufacturing of an exchanger 1 (or stage 2, 3 of an exchanger 1) using the machine 100 comprises the following steps.

A first layer 110 of powder 160 is deposited on the construction support 180 using the roller 130. At least one portion of this first layer 110 of powder 160 is brought to a temperature greater than the melting temperature of this powder 160 by the laser beam 195, such that the powder particles 160 of this portion of the first layer 110 are melted and form a first cordon 115 from a single part, secured to the construction support 180.

Then, the support 180 is lowered from a height corresponding to the thickness already defined from the first layer 110. A second layer 120 of powder 160 is deposited on the first layer 110 and on this first cordon 115, then at least one portion located partially or completely above this first cordon 115 is heated by exposure to the laser beam 195, such that the powder particles 160 of this portion of the second layer 120 are melted, with at least one portion of the first element 115, and form a second cordon 125. The assembly of these two cordons 115 and 125 forms a block made of a single part.

The process of constructing the part is then followed layer by layer, by adding additional layers of powder 160 on the assembly already formed. The scanning with the beam 195 makes it possible to construct each layer by giving it a shape according to the geometry of the part to be produced.

The three-dimensional (3D) exchanger 1 (or the stage 2, 3 of the exchanger 1) is therefore obtained by a superposition of two-dimensional (2D) layers, along the manufacturing axis Z.

The powder 160 is advantageously made of a material having a good thermal conductivity in order to maximise the thermal transfers between the first fluid and the second fluid, and thus increase the efficiency of the heat exchanger 1.

Advantageously, the powder 160 is metal and preferably steel or metal alloy, for example nickel-based.

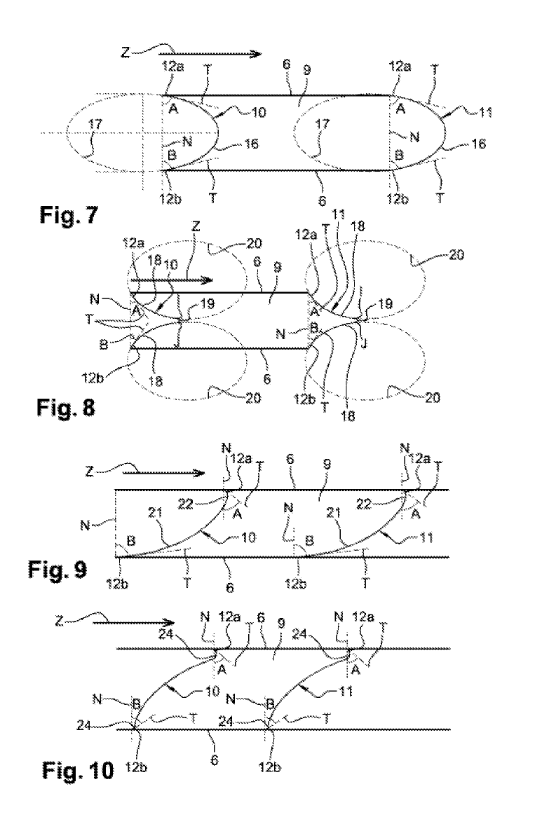

FIGS. 7 to 10 illustrate different embodiments of the invention.

According to a first embodiment represented in FIG. 7, for each fin 9, in a plane P, the first edge 10 comprises one single concave elliptical section 16. The elliptical section 16 corresponds to a section of a construction ellipsis 17 (represented by a dotted line), of which the centre is located equidistantly from the two plates 6, offset longitudinally with respect to the regions of connection 12a, 12b, the construction ellipsis 17 being tangent to the plates 6. The elliptical section 16 has an angle at the centre, of slightly less than 180°.

According to a second embodiment represented in FIG. 8, for each fin 9, in a plane P, the first edge 10 comprises two convex elliptical sections 18.

More specifically, each of the elliptical sections 18 converges from the corresponding plate 6. The two elliptical sections 18 are sealed by a fillet 19 (concave shape) so as to form a first and a second inflexion point I, J. The elliptical sections 18 each correspond to a section of a construction ellipsis 20 (represented as a dotted line) having an angle at the centre substantially equal to 90° (quarter of an ellipsis). These construction ellipses 20 are superposed, aligned and have the same dimensional characteristics.

According to a third embodiment represented in FIG. 9, for each fin 9, in a plane P, the first edge 10 comprises one single concave elliptical section 21. The elliptical section 21 corresponds to an elliptical section having an angle at the centre substantially equal to 90° (quarter of an ellipsis) and is connected to one of the plates 6 via a fillet 22 (concave shape).

According to a fourth embodiment represented in FIG. 10, for each fin 9, in a plane P, the first edge 10 comprises one single convex circular section 23. The circular section 23 corresponds to a circular arc having an angle at the centre substantially equal to 90° (quarter of a circle) and is connected to the plates 6 via a fillet 24 (concave shape).

To improve the mechanical and aerothermal performance, the sharp edges can be replaced by fillets (concave shape) or curves (convex shape).

The different embodiments illustrated of the fins 9 are not limiting. Indeed, according to the invention, the first edge 10 can contain one or more rectilinear sections and/or one or more curved sections, however, advantageously, more than 90% of the length of the first edge 10 (in a plane P) (and respectively of the second edge 11) is inclined with respect to the normal N, and preferably 95%.

1. Heat exchanger between a first fluid flowing in a longitudinal direction and a second fluid, said exchanger comprising:
two parallel plates distant from one another, so as to define a passage for circulating said first fluid;
at least one first and one second row of fins arranged perpendicularly between said plates, said first and second rows extending longitudinally, the fins of said first row being arranged preferably in staggered rows with respect to the fins of said second row, each fin being delimited longitudinally by a first edge and a second edge, said first edge comprising, at each of the ends thereof, a region of connection with the corresponding plate;
characterised in that said regions of connection of said first edge are respectively inclined by an angle (A) and an angle (B) with respect to a normal (N) to the plates in a plane (P) perpendicular to said plates and parallel with the direction (X), said first edge and said second edge of each of the fins having an identical profile in said plane (P).

2. The exchanger according to claim 1, wherein this angle (A) is equal to the angle (B).

3. The exchanger according to claim 1, wherein the angle (A) and/or the angle (B) is greater than 40°, and preferably greater than or equal to 45°.

4. The exchanger according to claim 1, wherein, in the plane (P), more than 90% of the length of the first edge is inclined with respect to the normal (N), and preferably more than 95%.

5. The exchanger according to claim 1, wherein said first edge comprises at least one rectilinear section inclined with respect to the normal (N) and/or at least one circular section and/or at least one elliptical section.

6. The exchanger according to claim 1, wherein said first edge comprises two rectilinear sections inclined with respect to the normal (N) and having concurrent directions.

7. The exchanger according to claim 1, wherein the fins are spaced longitudinally by a constant amount.

8. The method for producing an exchanger according to claim 1, wherein it comprises a step of producing said exchanger by additive manufacturing by selective melting on powder beds along a manufacturing axis (Z) parallel with said longitudinal direction (X).

9. The method according to claim 8, wherein said fins each comprise a first hollow edge and a second protruding edge, the exchanger being manufactured on a construction support, said first hollow edge being oriented on the side of said support.

10. The turbine engine comprising a heat exchanger according to claim 1.
